(19) United States
(12) Patent Application Publication
(10) Pub. No.: US 2003/0057772 A1
(43) Pub. Date: Mar. 27, 2003

(54) Power supply cut system for vehicle

(75) Inventor: Masanori Kunugi, Shizuoka (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/247,562

(22) Filed: Sep. 20, 2002

(30) Foreign Application Priority Data
Sep. 21, 2001 (JP) P2001-289729
Dec. 27, 2001 (JP) P2001-397438

(51) Int. Cl. B60L 1/00

(52) U.S. Cl. 307/9.1

(57) ABSTRACT

A power supply cut system for a vehicle in which a power supply line is set to a non-conducting state when an adapter supplied with power from a power supply for the vehicle is attached to a power supply socket. In the power supply cut system, power supply cut means is provided for setting the power supply line to the non-conducting state when the adapter is attached to the power supply socket and for setting the power supply line to a conducting state by completely loading the adapter in the power supply socket after attaching the adapter to the power supply socket.

### BACKGROUND OF THE INVENTION

1. Field of the Invention

The present invention relates to a power supply cut system for a vehicle, in which a power supply is cut during replacement of a service component, such as a fuse, a lamp, and a cigarette lighter.

2. Description of the Related Art

In an existing vehicle, a voltage of a power supply is as low as 14 V, and an arc discharge therefore hardly occurs even if a service component (a fuse, a lamp and the like) of an electrical device is replaced under conditions where the low voltage is applied. Accordingly, there has been no necessity for taking countermeasures against the arc discharge in replacement of the service component heretofore, and no countermeasures have been taken.

### SUMMARY OF THE INVENTION

However, in recent years, development of a high voltage vehicle of 42 V, which is equipped with a fuel-efficient motor generator, is being promoted. In such a high voltage vehicle, a voltage of a power supply is three times as high as that of the power supply (14 V) for the existing vehicle, and a probability of the arc discharge in replacement of the service component is also three times as high as that in the power supply for the existing vehicle. Accordingly, the countermeasures against the arc discharge are indispensable.

The present invention is made to solve the problem described above. An object of the present invention is to provide a power supply cut system for a vehicle in which an occurrence of the arc discharge in the replacement of the service component is prevented to ensure safety and disaster prevention without fail.

A first aspect of the present invention is a power supply cut system for a vehicle. The power supply cut system includes power supply cut means for setting a power supply line to a non-conducting state when a service component supplied with power from a power supply for the vehicle is attached to a device body of an electrical device and for setting the power supply line to a conducting state by completely loading the service component into the device body from a state in which the service component is attached to the device body.

In the power supply cut system according to the above described first aspect, when the service component is attached to the device body, the power supply line to the service component is set to the non-conducting state by the power supply cut means. Accordingly, replacement of the service component is carried out under conditions where a voltage of the power supply is not applied. When the service component is completely loaded into the device body from a state in which the service component is attached to the device body, the power supply line is set to the conducting state and the power is supplied to the service component.

A second aspect of the present invention is the power supply cut system according to the above described first aspect, in which the device body is a power supply socket and the service component is an adapter to be loaded into the power supply socket. The power supply socket has an insertion hole in which the service component is inserted in a freely rotatable manner, and the insertion hole is provided with power supply side contact points on a bottom wall and an inner circumferential wall thereof. The adapter is provided with load side contact points, which can be connected to the power supply side contact points, on a top surface and an outer circumferential surface thereof. The power supply cut means includes an insertion positioning structure for determining an insertion direction of the adapter with respect to the insertion hole. The insertion positioning structure isolates the power supply side contact points on the inner circumferential wall from the load side contact points on the outer circumferential surface when inserting the adapter into the insertion hole, and sets the power supply side contact points and the load side contact points to the conducting state by rotating the adapter by a predetermined angle.

In the power supply cut system according to the above described second aspect, in addition to a function of the first aspect of the present invention, the power supply cut means sets the power supply side contact points on the inner circumferential wall of the power supply socket and the load side contact points on the outer circumferential surface of the adapter to an mutually isolated state when the adapter is inserted in the insertion hole of the power supply socket, and sets the power supply side contact points and the load side contact points to the conducting state by rotating the adapter by the predetermined angle.

A third aspect of the present invention is the power supply cut system according to the above described first aspect, in which the power supply cut means sets the power supply line, which supplies the power to the service component, to the conducting state in a state where a cover of the electrical device is attached to the device body and sets the power supply line, which supplies the power to the service component, to the non-conducting state when the cover of the electrical device is detached from the device body.

In the power supply cut system according to the above described third aspect, when the cover is detached from the device body in order to replace the service component, the power supply line to the service component is set to the non-conducting state by the power supply cut means. Thus the replacement of the service component is carried out in a state where a voltage of the power supply is not applied.

A fourth aspect of the present invention is the power supply cut system according to the above described third aspect, in which the power supply cut means has a switch interposed in the power supply line for supplying the power to the service component and a switch pressing portion provided on the cover. The switch pressing portion turns on the switch in the state where the cover is attached to the device body, and turns off the switch when the cover is detached from the device body.

In the power supply cut system according to the above described fourth aspect, in addition to a function of the above described third aspect, the switch pressing portion of the cover turns on and off the switch.

A fifth aspect of the present invention is the power supply cut system according to the above described fourth aspect, in which the switch has a power supply side conductor connected to the power supply and a load side conductor connected to the service component. The power supply side conductor and the load side conductor come into a contacting state due to elastic deformation of at least one of the power supply side conductor and the load side conductor by means of a pressing force of the switch pressing portion, and the power supply side conductor and the load side conductor come into a non-contacting state due to deformation caused by elastic recovery of at least one of the power supply side conductor and the load side conductor by releasing the pressing force of the switch pressing portion.

In the power supply cut system according to the above described fifth aspect, in addition to a function of the above described fourth aspect, the switch can be composed of the power supply side conductor and the load side conductor, which are elastically deformable.

A sixth aspect of the present invention is the power supply cut system according to the above described fourth aspect, in which the switch pressing portion is a lock portion to be locked on a locked portion of the device body.

In the power supply cut system according to the above described sixth aspect, there is no necessity to provide a switch pressing portion separately, thus contributing to simplification of a constitution.

A seventh aspect of the present invention is the power supply cut system according to the above described third aspect, in which the power supply cut means has a switch interposed in the power supply line for supplying the power to the service component and a cover attachment/detachment detection unit for detecting attachment/detachment of the cover to/from the device body. The cover attachment/detachment detection unit outputs a cover attachment signal to turn on the switch in a state where the cover attachment/detachment detection unit is detecting the attachment of the cover, and outputs a cover detachment signal to turn off the switch when the cover attachment/detachment detection unit detects the detachment of the cover.

In the power supply cut system according to the above described seventh aspect, the switch is turned on and off by means of the electric signals, thus obtaining the similar function to the above described third aspect of the present invention.

### BRIEF DESCRIPTION OF THE DRAWINGS

FIG. 1 is a cross sectional view showing a first embodiment of the present invention, in a state in which an adapter is loaded into a cigarette lighter power supply socket.

FIG. 2 is a view showing the first embodiment of the present invention when viewed from a direction of the arrow II in FIG. 1.

FIG. 3A is a cross sectional view showing an insertion positioning structure according to the first embodiment of the present invention, in a state where the adapter is inserted therein and in a non-conducting state.

FIG. 3B is a cross sectional view showing the insertion positioning structure according to the first embodiment of the present invention, in the state where the adapter is inserted therein and in a conducting state.

FIG. 4A is a cross sectional view showing power supply cut means according to the first embodiment of the present invention, in the state whet e the adapter is inserted therein and in the non-conducting state.

FIG. 4B is a cross sectional view showing the power supply cut means according to the first embodiment of the present invention, in the state where the adapter is inserted therein and in the conducting state.

FIG. 5A is an exploded perspective view showing a room lamp device according to a second embodiment of the present invention.

FIG. 5B is a cross sectional view showing a power supply cut means according to the second embodiment of the present invention, in a state where a cover is attached thereto.

FIG. 5C is a cross sectional view showing the power supply cut means according to the second embodiment of the present invention, in a state where a cover is detached therefrom.

FIG. 6 is an exploded perspective view showing a fuse box according to a third embodiment of the present invention.

FIG. 7A is a cross sectional view showing a power supply cut means according to the third embodiment of the present invention, in a state where a cover is attached thereto.

FIG. 7B is a cross sectional view showing the power supply cut means according to the third embodiment of the present invention, in a state where a cover is detached therefrom.

### DESCRIPTION OF THE PREFERRED EMBODIMENTS

Hereinafter, the preferred embodiments of the present invention will be described with reference to the accompanying drawings.

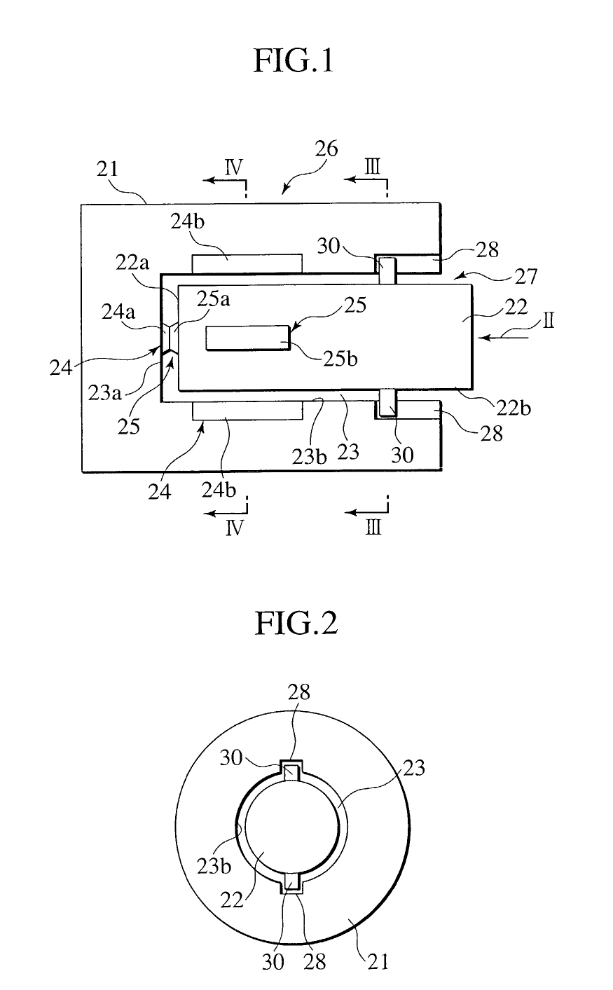

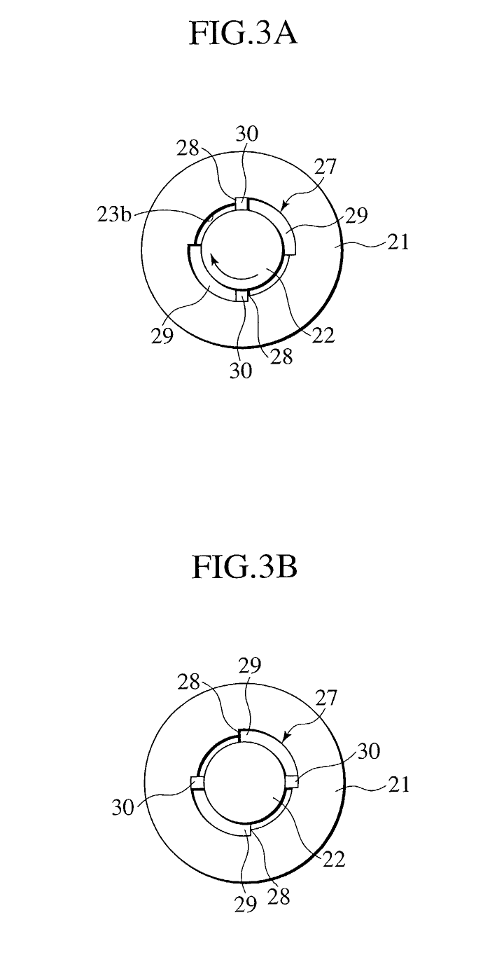

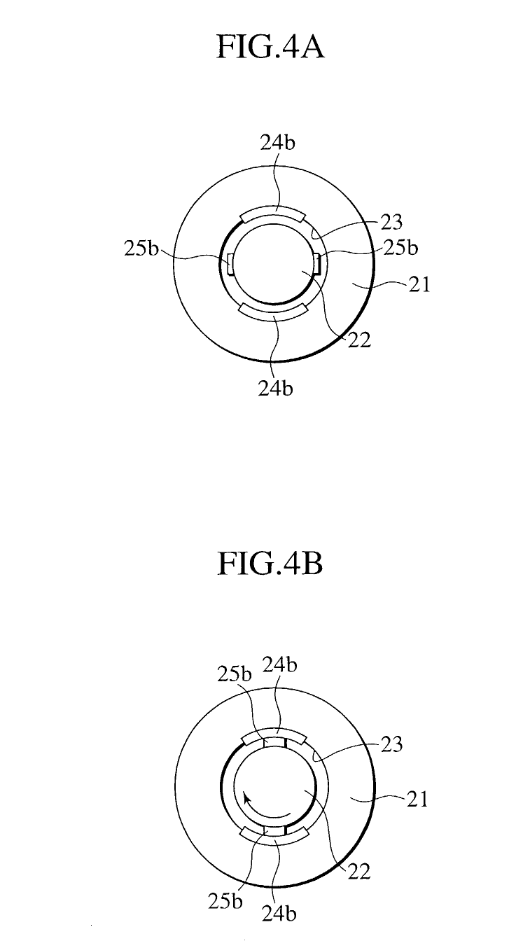

FIGS. 1 to 4 show a first embodiment of the present invention. In the first embodiment, a case in which a power supply cut system is applied to a cigarette lighter power supply socket 21 is shown. FIG. 1 is a cross sectional view showing a state in which an adapter 22 is loaded into the cigarette lighter power supply socket 21. FIG. 2 is a view showing the state of FIG. 1 when viewed from a direction of an arrow II. FIG. 3A is a cross sectional view (cross sectional view taken along a line III-III) showing an insertion positioning structure in a state where the adapter 22 is inserted therein and in a non-conducting state. FIG. 3B is a cross sectional view (cross sectional view taken along the line III-III) showing the insertion positioning structure in the state where the adapter 22 is inserted therein and in a conducting state. FIG. 4A is a cross sectional view (cross sectional view taken along a line IV-IV) showing power supply cut means in a state where the adapter 22 is inserted therein and in the non-conducting state. FIG. 4B is a cross sectional view (cross sectional view taken along the line IV-IV) showing the power supply cut means in the state where the adapter 22 is inserted therein and in the conducting state.

In FIG. 1, the cigarette lighter power supply socket (device body) 21 being an electrical device is arranged near to an ash tray in a center console unit or the like in an instrument panel of a vehicle. The power supply socket 21 is provided with the adapter 22 being a service component in a freely loadable manner. The adapter 22 is supplied with a power supply voltage (42 V) from a power supply (not shown) for the vehicle through a power supply line (not shown).

The power supply socket 21 being the device body has an insertion hole 23 in which the adapter 22 being the service component is inserted in a freely rotatable manner. The insertion hole 23 is provided with power supply side contact points 24 for supplying the power to the adapter 22.

On the other hand, the adapter 22 is provided with load side contact points 25 capable of being connected to the power supply side contact points 24 of the power supply socket 21. The load side contact points 25 and the power supply side contact points 24 collectively form the power supply cut means 26.

The power supply side contact points 24 consist of a plus (+) contact point (positive electrode) 24a provided on a bottom wall 23a of the insertion hole 23 and a pair of minus (−) contact points (negative electrode) 24b provided on an inner circumferential wall 23b thereof in a mutually facing manner. The load side contact points 25 consist of a plus (+) contact point (positive electrode) 25a provided on a top portion 22a of the adapter 22 and a pair of minus (−) contact points (negative electrode) 25b provided on an outer circumferential surface 22b thereof in a mutually facing manner.

The power supply cut means 26 includes the insertion positioning structure 27 for determining an insertion direction of the adapter 22 with respect to the insertion hole 23 of the power supply socket 21. As shown in FIGS. 2, 3A and 3B, the insertion positioning structure 27 is composed of a pair of insertion guiding grooves 28 formed on the inner circumferential wall 23b of the insertion hole 23 of the power supply socket 21 in an axial direction of the power supply socket 21 in a mutually facing manner, positioning grooves 29 respectively formed so as to communicate with end portions of the insertion guiding grooves 28 in a range of 90 degrees in a circumferential direction of the power supply socket 21, and a pair of guided portions 30 provided on the outer circumferential surface 22b of the adapter 22, which is respectively inserted into the pair of insertion guiding grooves 28 and the positioning grooves 29 slidably.

The pair of insertion guiding grooves 28 of the insertion hole 23 are respectively formed coaxially with the pair of minus (−) contact points 24b being the power supply side contact points 24. On the other hand, the pair of guided portions 30 of the adapter 22 are provided to be respectively tilted by 90 degrees in the circumferential direction with respect to the pair of minus (−) contact points 25b being the load side contact points 25 of the power supply socket 21.

Next, a description will be made for an insertion operation of the adapter 22 into the power supply socket 21.

When the adapter 22 is inserted into the power supply socket 21, the pair of guided portions 30 of the adapter 22 are caused to follow the pair of insertion guiding grooves 28 of the power supply socket 21 as shown in FIG. 3A. At this time, the power supply side contact points 24 provided on the inner circumferential wall 23b of the insertion hole 23 and the load side contact points 25 provided on the outer circumferential surface 22b of the adapter 22 are isolated from each other as shown in FIG. 4A, thus setting the power supply line for supplying the power to the adapter 22 to the non-conducting state. From this state, the adapter 22 is rotated by 90 degrees while the pair of guided portions 30 of the adapter 22 are respectively moved along the pair of positioning grooves 29 of the power supply socket 21 as shown in FIG. 3B, and the adapter 22 is thereby positioned and fixed to the power supply socket 21. Thus the load side contact points 25 provided on the outer circumferential surface 22b of the adapter 22 are connected to the power supply side contact points 24 provided on the inner circumferential wall 23b of the insertion hole 23 as shown in FIG. 4B and the power supply line for supplying the power to the adapter 22 is set to the conducting state.

According to the-present invention, in the state where the adapter 22 is inserted into the power supply socket 21, the power supply side contact points 24 and the load side contact points 25 are not allowed to be in the conducting state. By rotating the adapter 22 by a predetermined angle (90 degrees), the power supply side contact points 24 and the load side contact points 25 come into the conducting state. In other words, in the state where the adapter 22 is inserted into the power supply socket 21, the power supply line is in the non-conducting state; in the state where the adapter 22 is rotated by the predetermined angle to be completely loaded into the power supply socket 21, the power supply line is in the conducting state. Accordingly, an arc discharge does not occur in the state where the adapter 22 is inserted into the power supply socket 21. The arc discharge occurs when the adapter 22 is rotated by the predetermined angle to bring the power supply side contact points 24 into contact with the load side contact points 25. In this case, the arc discharge occurs at a top portion side of the adapter 22 and inside the power supply socket 21. Therefore an electric spark and the like due to the arc discharge do not come out of the power supply sockets 21, and replacement of the service component (adapter 22) is thereby carried out in safety.

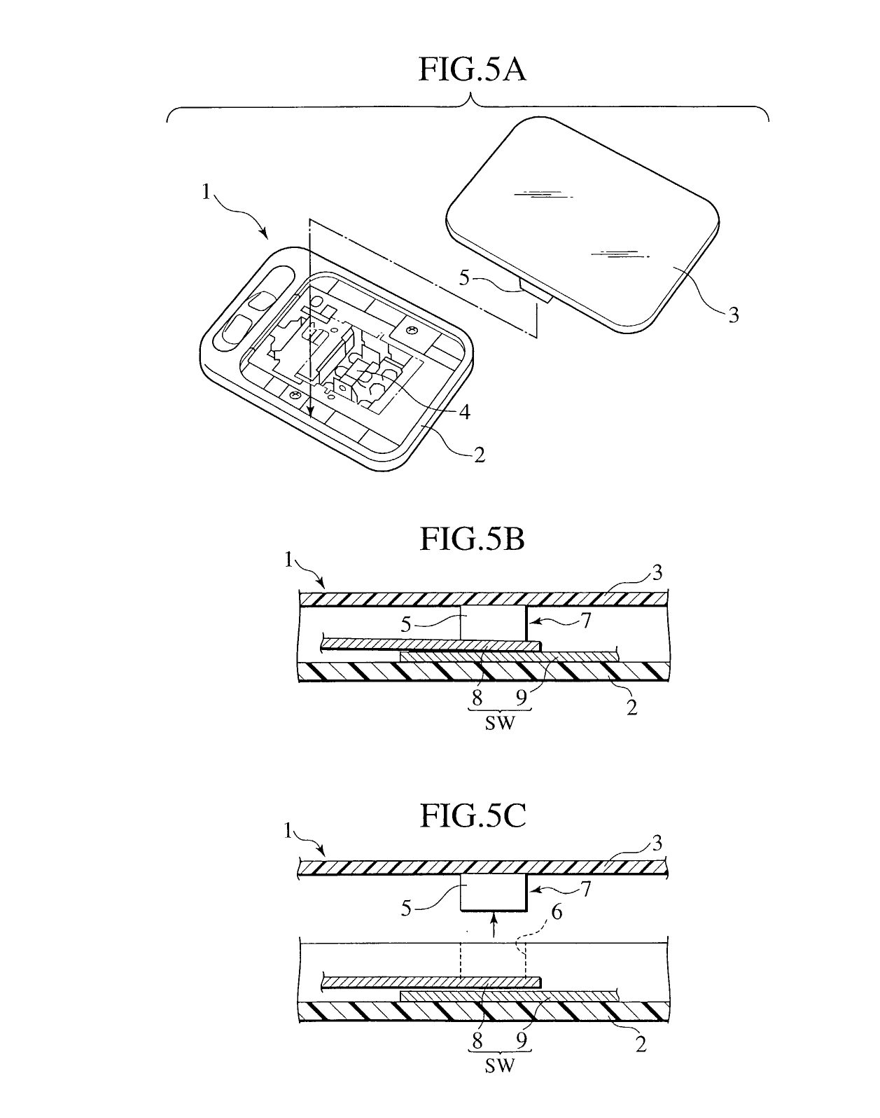

FIGS. 5A to 5C show a second embodiment of the present invention. In the second embodiment, a case in which a power supply cut system is applied to a room lamp device 1 is shown. FIG. 5A is an exploded perspective view of the room lamp device 1. FIG. 5B is a cross sectional view of power supply cut means 7 in a state where a cover 3 is attached thereto. FIG. 5C is a cross sectional view of the power supply cut means 7 in a state where the cover 3 is detached therefrom.

In FIGS. 5A to 5C, the room lamp device 1 being an electrical device is arranged on a ceiling or the like in a vehicle, and includes a device body 2 and the cover 3 provided on the device body 2 in a freely attachable and detachable manner. The device body 2 is provided with a lamp 4 being a service component in a freely attachable and detachable manner. The lamp 4 is normally covered with the cover 3. By detaching the cover 3 from the device body 2, the lamp 4 is exposed outside. The lamp 4 is supplied with a power supply voltage (42 V) from a power supply (not shown) for the vehicle through a power supply line (not shown).

The cover 3 has a lens function for irradiating light of the lamp 4 onto a desired area. The cover 3 is provided with a lock portion 5 being a switch pressing portion. The cover 3 is attached to the device body 2 by locking the lock portion 5 on a locked portion 6 (shown in FIG. 5C) of the device body 2, and the cover 3 is detached from the device body 2 by releasing the lock portion 5 from the locked portion 6 of the device body 2.

In addition, the room lamp device 1 is provided with the power supply cut means 7. The power supply cut means 7 is composed of a switch SW interposed in the power supply line for supplying the power to the lamp 4 and the lock portion 5 being the switch pressing portion for turning on and off the switch SW.

The switch SW is formed utilizing bus bars being components of the power supply line in the room lamp device 1. An end portion of a power supply side conductor 8 being the bus bar connected to a power supply side and an end portion of a load side conductor 9 being the bus bar connected to a lamp side are arranged to be spaced away in a vertical direction in an overlapping state, thus forming the switch SW. In the state where the cover 3 is attached to the device body 2 as shown in FIG. 5B, the lock portion 5 presses the power supply side conductor 8 downwardly and both the conductors 8 and 9 are therefore in a contacting state; when the cover 3 is detached from the device body 2 as shown in FIG. 5C, the press of the lock portion 5 is released and the power supply side conductor 8 is deformed due to elastic recovery, thus setting both the conductors 8 and 9 to a non-contacting state.

Next, replacement of the lamp 4 will be described. In the state where the cover 3 is attached to the device body 2 as shown in FIG. 5B, the lock portion 5 presses the power supply side conductor 8 downwardly to set both the conductors 8 and 9 to the contacting state, and the power supply voltage is therefore supplied to the lamp 4. In this state, a user releases the lock portion 5 of the cover 3 and detaches the cover 3 from the device body 2. As a result, the power supply side conductor 8 is deformed due to the elastic recovery to set both the conductors 8 and 9 to the non-contacting state as shown in FIG. 5C, thus stopping the supply of the power supply voltage to the lamp 4. Next, the user detaches the lamp 4 from the device body 2 and attaches a new lamp 4 to the device body. After attaching the new lamp 4 to the device body, the user attaches the cover 3 to the device body 2 again. As a result, the lock portion 5 of the cover 3 presses the power supply side conductor 8 downwardly to set both the conductors 8 and 9 to the contacting state, thus supplying the lamp 4 with the power supply voltage.

As described above, in the power supply cut system for a vehicle, when the cover 3 is detached from the device body 2 in order to replace the lamp 4, the power supply line to the lamp 4 is set to a non-conducting state by the power supply cut means 7, and the replacement of the lamp 4 is carried out under conditions where the power supply voltage is not applied. Accordingly, it is possible to prevent an occurrence of the arc discharge during the replacement of the lamp 4 and to ensure safety and disaster prevention without fail.

Moreover, in the above described second embodiment, the power supply cut means 7 is composed of the switch SW interposed in the power supply line for supplying the power to the lamp 4 and the lock portion 5 provided on the cover 3. The lock portion 5 turns on the switch SW in the state where the cover 3 is attached to the device body 2 and turns off the switch SW when the cover 3 is detached from the device body 2. Accordingly, since the lock portion 5 of the cover 3 turns on and off the switch SW, the power supply cut system for a vehicle can be constructed in the room lamp device 1.

Moreover, in the above described second embodiment, the switch SW has the power supply side conductor 8 connected to the power supply and the load side conductor 9 connected to the lamp 4. When the power supply side conductor 8 undergoes elastic deformation by a pressing force of the lock portion 5, the switch SW comes into the contacting state; when the power supply side conductor 8 is deformed due to the elastic recovery by releasing the pressing force of the lock portion 5, the switch SW comes into the non-contacting state. Accordingly, since the switch SW can be composed only of the elastically deformable power supply side conductor 8 and the load side conductor 9, the switch SW can be formed easily. Alternatively, the switch SW may be formed in such a manner that the load side conductor 9 is deformed elastically or deformed due to elastic recovery by the lock portion 5 to achieve conducting/non-conducting of the power supply line. Alternatively, the switch SW may be formed in such a manner that both of the power supply side conductor 8 and the load side conductor 9 are deformed elastically or deformed due to elastic recovery by the lock portion 5 to achieve conducting/non-conducting of the power supply line.

Moreover, in the above described second embodiment, the lock portion 5 is used as the switch pressing portion. Accordingly, there is no necessity to provide a switch pressing portion separately, thus contributing to simplification of a constitution. However, as a matter of course, in a case where the switch SW cannot be arranged under the lock portion 5 of the cover 3 due to restriction of bus bar installation, the switch pressing portion may be provided in addition to the lock portion 5.

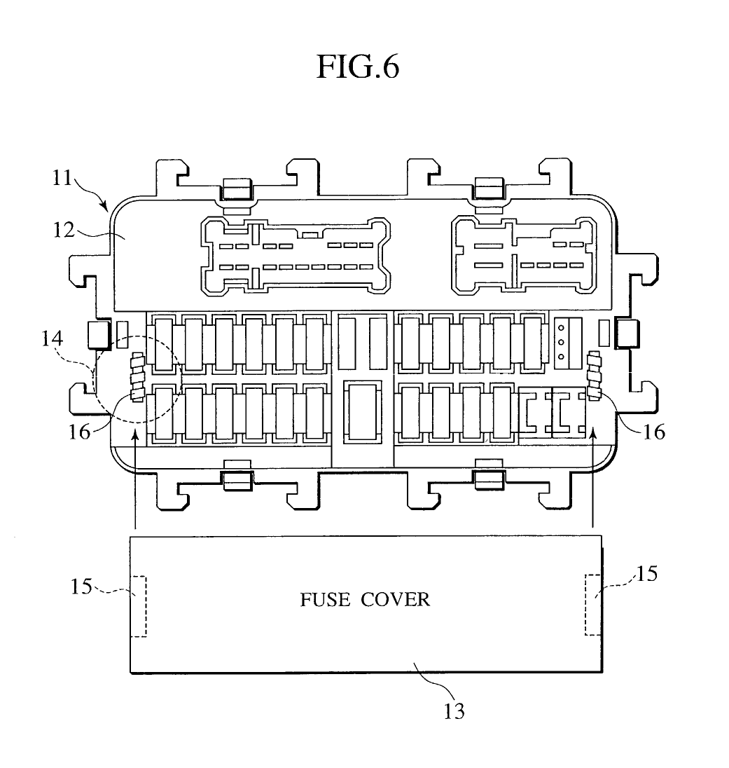

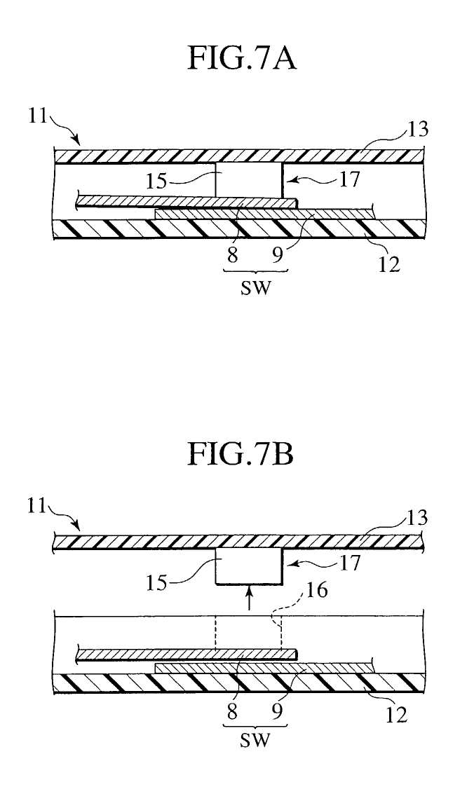

FIGS. 6, 7A and 7B show a third embodiment of the present invention. In the third embodiment, a case in which a power supply cut system is applied to a fuse box 11 is shown. FIG. 6 is an exploded perspective view of the fuse box 11. FIG. 7A is a cross sectional view of power supply cut means 17 in a state where a cover 13 is attached thereto. FIG. 7B is a cross sectional view of the power supply cut means 17 in a state where the cover 13 is (detached therefrom.

The fuse box 11 being an electrical device includes a device body 12 and the cover 13 provided to the device body 12 in a freely attachable and detachable manner as shown in FIG. 6. The device body 12 is provided with a lot of fuses 14 being service components in a freely attachable and detachable manner. The fuses 14 are normally covered with the cover 13. By detaching the cover 13 from the device body 12, the fuses 14 are exposed outside. The fuses 14 are supplied with a power supply voltage (42 V) from a power supply (not shown) for a vehicle through a power supply line (not shown). The cover 13 is provided with a lock portion 15 being a switch pressing portion. The cover 13 is attached to the device body 12 by locking the lock portion 15 on a locked portion 16 of the device body 12, whereas the cover 13 is detached from the device body 12 by releasing the lock portion 15 from the locked portion 16 of the device body 12.

The fuse box 11 is provided with the power supply cut means 17. Since a constitution of the power supply cut means 17 is identical to that of the second embodiment, equivalent parts in the drawings are given the same reference numerals and descriptions thereof will be omitted.

The similar function and effect to those of the above described second embodiment are obtained by means of the power supply cut system for a vehicle of the third embodiment. Specifically, when the cover 13 is detached from the device body 12 in order to replace the fuses 14, the power supply line to the fuses 14 is set to a non-conducting state by the power supply cut means 17, and the replacement of the fuses 14 is carried out under conditions where the power supply voltage is not applied. Accordingly, it is possible to prevent an occurrence of the arc discharge during the replacement of the fuses 14 and to ensure safety and disaster prevention without fail.

Next, another embodiment will be described. Power supply cut means of the embodiment has a switch (such as a relay) interposed in a power supply line for supplying power to a service component and a cover attachment/detachment detection unit for detecting attachment/detachment of a cover to/from a device body. The power supply cut means is formed in such a manner that the cover attachment/detachment detection unit outputs a cover attachment signal to turn on the switch in a state where the cover attachment/detachment detection unit is detecting the attachment of the cover and outputs a cover detachment signal to turn off the switch when the cover attachment/detachment detection unit detects the detachment of the cover. As described above, also in the case where the power supply cut means is formed so that the switch is turned on and off by means of the electric signals, it is possible to prevent an occurrence of the arc discharge during replacement of the service component and to ensure safety and disaster prevention without fail, similarly to the second and third embodiments described above. Incidentally, according to the first, second and third embodiments, the descriptions have been made for the cases in which the power supply cut system for a vehicle of the present invention is applied to the cigarette lighter power supply socket 21, the room lamp device 1 and the fuse box 11. However, as a matter of course, the power supply cut system can be applied to all electrical devices having embedded service components to be replaced.

What is claimed is:

1. A power supply cut system for a vehicle, comprising:
power supply cut means for setting a power supply line to a non-conducting state when a service component supplied with power from a power supply for the vehicle is attached to a device body of an electrical device and for setting the power supply line to a conducting state by completely loading the service component into the device body from a state in which the service component is attached to the device body.

2. The power supply cut system according to claim 1, wherein
the device body is a power supply socket provided with an insertion hole in which the service component is inserted in a freely rotatable manner and power supply side contact points, the power supply side contact points being provided on a bottom wall of the insertion hole and an inner circumferential wall thereof,
the service component is an adapter of which top surface and outer circumferential surface are provided with load side contact points connectable to the power supply side contact points, the adapter being loaded into the power supply socket,
the power supply cut means has an insertion positioning structure for determining an insertion direction of the adapter with respect to the insertion hole, and
the insertion positioning structure isolates the power supply side contact points on the inner circumferential wall from the load side contact points on the outer circumferential surface when inserting the adapter into the insertion hole and sets the power supply side contact points and the load side contact points to the conducting state by rotating the adapter by a predetermined angle.

3. The power supply cut system according to claim 1, wherein
the power supply cut means sets the power supply line, which supplies the power to the service component, to the conducting state in a state where a cover of the electrical device is attached to the device body and sets the power supply line, which supplies the power to the service component, to the non-conducting state when the cover of the electrical device is detached from the device body.

4. The power supply cut system according to claim 3, wherein
the power supply cut means includes:
a switch interposed in the power supply line for supplying the power to the service component; and
a switch pressing portion provided on the cover, the switch pressing portion turning on the switch in the state where the cover is attached to the device body and turning off the switch when the cover is detached from the device body.

5. The power supply cut system according to claim 4, wherein
the switch has a power supply side conductor connected to the power supply and a load side conductor connected to the service component, and
the power supply side conductor and the load side conductor come into a contacting state due to elastic deformation of at least one of the power supply side conductor and the load side conductor by means of a pressing force of the switch pressing portion, and the power supply side conductor and the load side conductor come into a non-contacting state due to deformation caused by elastic recovery of at least one of the power supply side conductor and the load side conductor by releasing the pressing force of the switch pressing portion.

6. The power supply cut system according to any one of claims 4, wherein
the switch pressing portion is a lock portion to be locked on a locked portion of the device body.

7. The power supply cut system according to claim 3, wherein
the power supply cut means has a switch interposed in the power supply line for supplying the power to the service component and a cover attachment/detachment detection unit for detecting attachment/detachment of the cover to/from the device body, and
the cover attachment/detachment detection unit outputs a cover detachment signal to turn off the switch in a state where the cover attachment/detachment detection unit is detecting the detachment of the cover.
